(19) United States
(12) Patent Application Publication
(10) Pub. No.: US 2005/0068788 A1
(43) Pub. Date: Mar. 31, 2005

(54) Electro-optic through-hole mount light pipe and connector

(76) Inventors: Weston C. Roth, Hillsboro, OR (US); Damion T. Searls, Hillisboro, OR (US); Thomas O. Morgan, Hillsboro, OR (US); James D. Jackson, Beaverton, OR (US)

Correspondence Address: Ami Patel Shah;BLAKELY, SOKOLOFF, TAYLOR & ZAFMAN LLP, Seventh Floor, 12400 Wilshire Boulevard, Los Angeles, CA, 90025-1030, US

(21) Appl. No.: 10/676,627

(22) Filed: Sep. 30, 2003

(51) Int. Cl. G02B 6/36; G02B 6/00

(52) U.S. Cl. 362/551

(57) ABSTRACT

A light pipe component designed with optically transparent material capable of transmitting and/or guiding optical wavelengths. The outer surface of each light pipe being coated with a metallic surface finish, with the exception of the ends of the light pipe. The light pipe component being placed on a PCB to form solder joints between the metallic surface finish of the light pipes and the PTH. The solder joints may now be used for transmitting both optical signals and electrical signals per each physical connection of the light pipes.

### BACKGROUND INFORMATION

Current light pipe component technologies use a press fit connector attachment mechanism to secure the light pipe components to a printed circuit board (PCB). This is an acceptable means of component attachment, however, it does not provide any means of forming electrical connections to the PCB. Neither does it provide dual connections per light pipe component.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is a front elevation view of a light pipe of the present invention.

FIG. 2 is perspective view of a light pipe array.

FIG. 3 is a perspective view of the light pipe array attached to a PCB substrate.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well know devices, circuits, and methods are omitted so as not to obscure the description of the present invention with unnecessary detail.

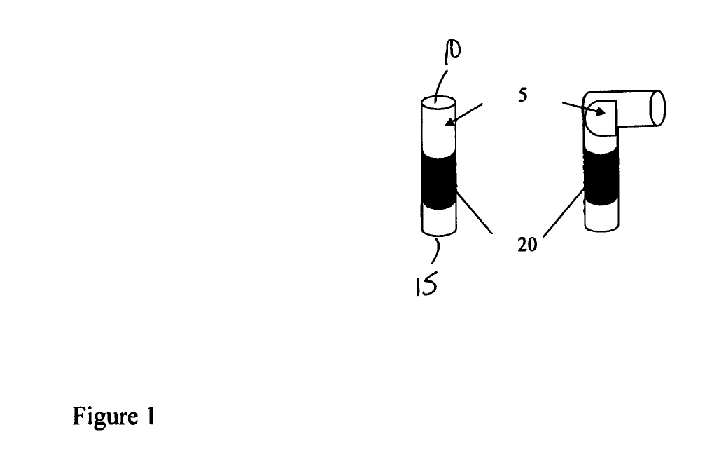

FIGS. 1-3 illustrates a light pipe component 5 having a top surface 10 and a bottom surface 15. As shown in FIG. 1, light pipes 5 can come in various shapes such as a vertical light pipe and a right angled light pipe. The cylindrical light pipe 5 or fiber optic wave guide has light transmitted through its bottom surface. The light pipe 5 itself may be any single or N by M light pipes inside a component housing 40 (where N and M represent integers).

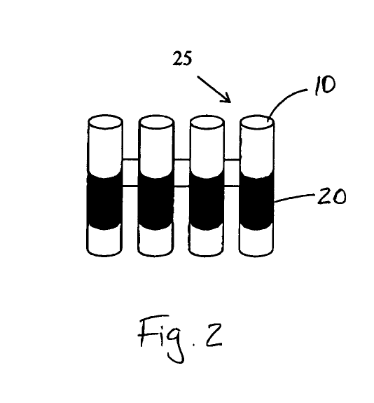

The individual light pipes 5 may consist of an optically transparent material capable of transmitting and/or guiding optical and near optical (e.g. infrared, ultraviolet) wavelengths. The cylindrical surface of each light pipe 5 may be coated with a metallic surface finish 20 (e.g. HASL, OSP, etc), with the exception of the top and bottom surfaces 10, 15 of the light pipe 5, which remain uncoated to enable the transmission of optical signals. The light pipes may also be connected in a vertical 4× light array 25 as shown in FIG. 2.

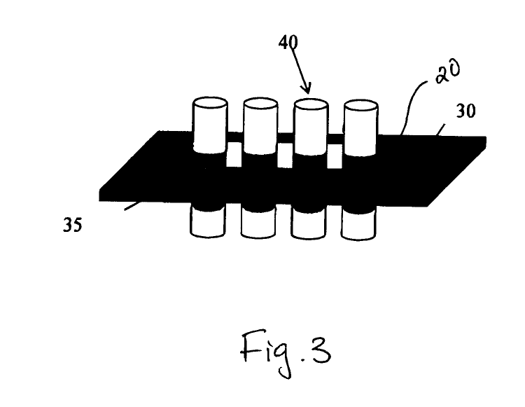

Assembly of the light pipe 5 onto the PCB will now be described referring to FIG. 3. The light pipes 5 can be placed on the PCB 30 with the top and bottom surfaces 10, 15 of light pipes 5 fitting inside a single or N by M array 25 of plated through holes (PTH) (not shown) on the PCB. The PCB may then be processed over a wave solder machine to form solder joints 35 between the metallic surface finish 20 on the light pipes 5 and the PTH. Upon completion of this processing, light pipes 5 are mechanically attached to the PCB 30 by means of the solder joint 35. The solder only wets and coats those portions of the surfaces that are coated with the metallic finish, the other surfaces that are uncoated are not covered with solder. Optical signals may be transmitted through the individual light pipes 5 within a component housing 40. Additionally, the solder joints enable routing of electrical signals.

The proposed component design 40 integrates both electrical and optical signal paths into a signal connector. This doubles the signal density of existing connectors, saving PCB surface area and increasing platform feature density. By coating the outer surface of the light pipe 5 with a metallic surface finish 20, using PTH, and a wave solder process, the light pipe 5 can be attached mechanically to the PCB 30 by means of a solder joint 35. The advantage of using THM solder attach technology is it makes use of existing HVM wave solder processes to mechanically attach the light pipe to the substrate by means of a solder joint. This solder joint 35 can then be used to provide an electrical signal path for control signals, data, or power delivery. By leaving the top and bottom surfaces 10, 15 of the light pipe 5 clear, optical signals can be transmitted.

The proposed component 40 can therefore transmit two signals per physical connection, one optical and one electrical. This enables a reduction of the connector footprint, saving valuable PCB surface area to increase feature density. The integrated electro-optical connection provides optical channels to support high-speed signals (e.g. high speed serial, 3-GIO) and electrical channels to support slower, legacy signals (e.g. PCI) and/or power delivery.

As PCB technology progresses toward faster signaling rates, optical signaling technology is one possible direction for future Intel products. The proposed electro-optic light pipe may be a key technology building block for an optical PCB signaling infrastructure. By integrating the electrical and mechanical properties of a THM solder attach technology with an optical light pipe component one can save PCB space and simplify the design and assembly of hybrid electrical-optical PCB connectors. PCB designers can take advantage of the increased bandwidth of optical transmission to route high-speed signals, while at the same time use the electrical-mechanical solder-joints to support legacy signals and /or power delivery. The proposed component also makes use of commercially available high volume manufacturing (HVM) and assembly processes, making it relatively inexpensive to manufacture and assemble.

The foregoing and other aspects of the invention are achieved individually and in combination. The invention should not be construed as requiring two or more of the such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

1. A component housing comprising:
a substrate;
a light pipe having a top and bottom surface is fitted through a bore in the substrate; and
a metallic surface finish coated on the cylindrical surface of the light pipe,
wherein a solder joint is formed between the metallic finish and the bore in the substrate.

2. The component housing of claim 1 wherein light is transmitted through the bottom surface of the light pipe.

3. The component housing of claim 1, wherein the light pipe can be an array of light pipes.

4. The component housing of claim 1, wherein the substrate is a PCB.

5. The component housing of claim 1, wherein the light pipe is comprised of optically transparent material capable of transmitting optical signals.

6. The component housing of claim 1, wherein the solder joints the cylindrical portion of the light pipe coated with the metallic finish.

7. The component housing of claim 1, wherein the solder joint transmits both optical and electrical signals.

8. The component housing of claim 1, wherein the light pipe is mechanically attached to the substrate by the solder joint.

9. The component housing of claim 1, wherein the substrate enables transmission of two signals for each light pipe connection.

10. The component housing of claim 1, wherein the metallic finish is OSP.

11. The component housing of claim 1, wherein the metallic finish is HASL.
